(19) United States
(12) Patent Application Publication
(10) Pub. No.: US 2024/0218709 A1
(43) Pub. Date: Jul. 4, 2024

(54) SLOT LOCKS AND SECURITY SLOTS THEREFOR

(71) Applicant: Meir Avganim, Gealya (IL)

(72) Inventor: Meir Avganim, Gealya (IL)

(21) Appl. No.: 18/397,156

(22) Filed: Dec. 27, 2023

Related U.S. Application Data
(60) Provisional application No. 63/436,311, filed on Dec. 30, 2022.

(51) Int. Cl. E05B 73/00

(52) U.S. Cl. CPC E05B 73/0082; E05B 73/0005

(57) ABSTRACT

A lock assembly for preventing theft of an electronic mobile device (EMD) is configured to engage a slot formed in the 2 mm thick outer wall of the EMD. The slot has top and bottom outwardly-flaring side walls extending away from the opening. The lock body supports first and second locking elements, each of which is configured to be insertable into the slot and has a top wall and a bottom wall that are complementary in shape to the top wall and the bottom wall the of the slot. The first and second locking elements cooperate structurally to become wedged inside the slot in manner that prevents separation of the lock body from the EMD while the first and second locking elements are positioned inside the slot.

### CROSS-REFERENCE TO RELATED APPLICATION

The present non-provisional patent application claims the benefit of and priority to U.S. Provisional Patent Application No. 63/436,311, filed Dec. 30, 2022, by Meir Avganim, and entitled “SLOT LOCKS AND SECURITY SLOTS THEREFOR,” the entire contents of which are incorporated herein by reference.

### BACKGROUND OF THE INVENTION

The present invention relates to security slots for electronic mobile devices (EMD) and, more particularly, to security slots that are fashioned at and from the openings that are provided at the locations of the USB-C electrical ports of EMDs. The present disclosure also relates slot-style locks that are capable of being locked to or at such security slots, which locks include cables by which the EMD can be tethered to an immovable object to prevent its theft.

The present disclosure builds upon and elaborates on prior disclosures and similar technology of the present inventor including as described in his U.S. Pat. No. 9,549,476 B2 and in his pending U.S. patent application Ser. No. 18/085,139 (US 2023/0203849 A1), filed Dec. 20, 2022, the contents of which are both incorporated by reference herein.

### SUMMARY OF THE INVENTION

It is an object of the present invention is to provide security slots that are defined inside the opening into the USB-C sock of EMDs.

Another object of the present disclosure is to provide locks that are usable with the security slots for EMDs described herein, and equivalents of such slots.

The present disclosure refers and describes different embodiments of the present invention including a lock assembly for preventing theft of an electronic mobile device (EMD) having a slot formed in an outer wall of the EMD, wherein the outer wall has a thickness of less than 2.5 millimeters measured from a front surface to a rear surface of the outer wall, and the slot has an opening thereinto at the front surface, the slot having arcuately-shaped left and right walls, and top and bottom outwardly flaring walls extending between the left and right arcuately-shaped walls and away from the opening at the front surface of the outer wall to an opening at the rear surface of the outer wall, the lock assembly including:
a lock body including a user-controlled locking mechanism;
a first locking element that protrude from a front wall of the lock body, and the first locking element is configured to be insertable into the slot via the opening at the front surface and has a top wall that is complementary in shape to the top wall of the slot and configured to be laterally and slidingly movable in the slot to tightly engage the top wall of the slot, and the first locking element is configured to prevent insertion thereof beyond the outer surface of the slot;
a second locking element that is insertable into the slot via the opening at the front surface and has a bottom wall that is complementary in shape to the bottom wall of the slot and a configuration that prevents insertion of the first locking element beyond the outer surface of the slot, the first and second locking elements cooperating structurally with each other to become wedged inside the slot in a manner that prevents separation of the lock body from the EMD while the first and second locking elements are positioned inside the slot; and
a cable assembly coupled to the lock body and configured to enable affixing the lock body to an immovable object, whereby when the lock body is affixed to the EMD via the locking elements being engaged with the slot, theft of the EMD is prevented.

The locking mechanism may be coupled to the second locking element and configured to lock the second locking element inside the slot.

The first and second locking elements may extend from the lock body at a length in the range from 1.9 to 2.25 mm.

The second locking element may be slidable into and out of the lock body.

The first and second locking elements may have substantially same height dimensions and a width dimension of the first locking elements is at least three times as large as a width dimension of the second locking element.

The lock body may have a bottom surface and the first and second locking elements are provided at a front surface of the lock body, at height that does not exceed 2.5 mm above the bottom surface of the lock body.

The locking mechanism may be key-operated.

The EMD may be a laptop.

The opening at the front surface into the slot is registered with a USB socket located inside the EMD and accessible through said opening.

The slot has arcuately-shaped left and right flaring side walls that extend away from the opening at the front surface to the opening at the rear surface of the outer wall, wherein the first locking element has an arcuately-shaped side that is complementary in shape to the left outwardly flaring side wall and is configured to tightly engage the left outwardly flaring side wall of the slot, wherein the second locking element has an arcuately-shaped side that is complementary in shape to the right, outwardly flaring side wall of the slot and a configuration that prevents insertion of the first locking element beyond the outer surface of the slot.

The arcuately-shaped walls may extend over an arc angle in the range of 120 to 180 degrees, and wherein the arcuately-shaped side of at least one of the first and second locking elements has an arc-angle of between 120 to 180 degrees, for example 180 degrees.

The top and the bottom walls and/or the right and left walls may flare at an angle in the range of from 25 to 75 degrees relative to a plane of the opening into the slot, for example 35 degrees.

The arcuately-shaped side of the first locking element may be oriented on a side thereof opposite to the location of the arcuately-shaped side of the second locking element, and the first and second locking elements are insertable together into the slot.

Other features and advantages of the present invention will become apparent from the following description of the invention which refers to the accompanying drawings.

### BRIEF DESCRIPTION OF THE DRAWINGS

FIG. 1 diagrammatically shows the contours and shape of USB-based security slot according to a first embodiment.

FIG. 2 diagrammatically shows the contours and shape of USB-based security slot according to a second embodiment.

FIG. 3 is a hand sketch of the above security slots.

FIG. 3A is a sketch of one of the slots of FIG. 3.

FIG. 4A is a perspective of one of the slots in FIG. 3

FIG. 4B is a perspective of another of the slots in FIG. 3.

FIGS. 5A through 5E show a security lock that is configured to lock within the security slot of FIG. 2.

### DETAILED DESCRIPTION OF PREFERRED EMBODIMENTS OF THE INVENTION

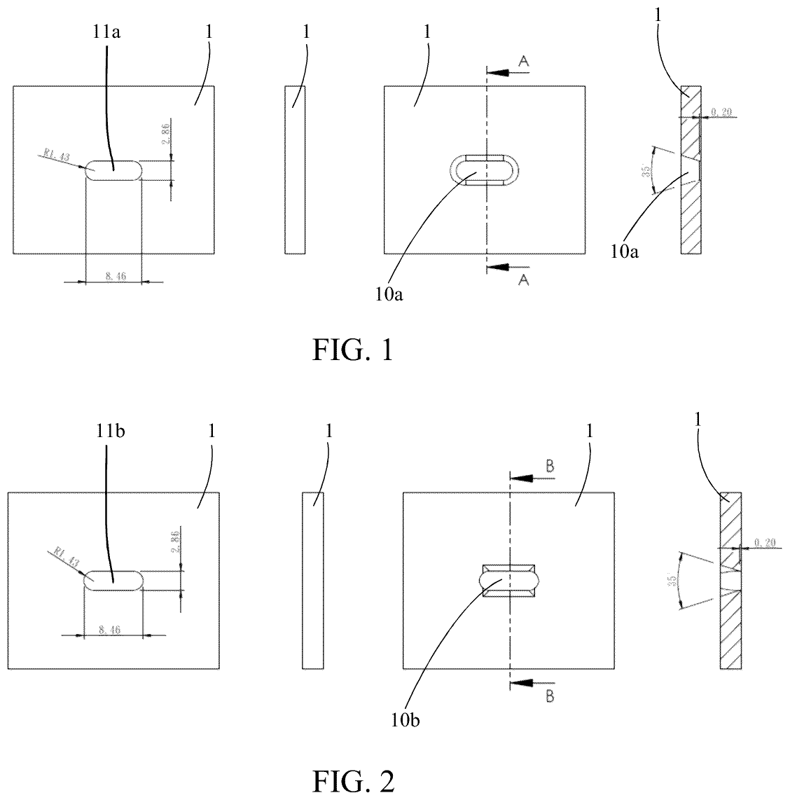

In FIG. 1, at the left is shown the outer wall 1 of the EMD (not shown) in which is formed the conventional USB-C socket opening 11a, behind which is typically located the USB-C electrical socket (not shown). The opening 11a is shown in this figure to measure 2.86 by 8.46 millimeters, which is a conventional size. The side walls of the opening 11a are curved as shown. In the conventional USB-C openings, the interior walls of the opening are perpendicular to the outer (and inner) wall surface of the wall 1.

Departing from the prior art and as shown in the two right side sub-figures, the interior walls defining the interior shape of the security slot 10a are sloped, non-parallel to the outer surface of the wall 1, flaring outwardly from an opening at the front of the wall 1 to an opening at the rear of the wall 1. The angle of the inclined/sloped wall is shown in FIG. 1 to be 35 degrees, which is only one option as the angle can be in the range of 25 to 75 degrees. In the embodiment of FIG. 1, the curved interior wall extends all around the edges of the slot 10a. The dimensional thickness of the wall 1 is extremely small, on the order of about 2 mm.

The slot embodiment in FIG. 2 is generally similar to that of FIG. 1, except that the interior walls of the slot 10b that are inclined to the outer surface of the wall 1 are provided only along the top and bottom edges of the slot 10b, the top and bottom walls flaring outwardly from an opening at the front of the wall 1 to an opening at the rear of the wall 1. The interior walls at the right and left of the slot remain as in the prior art. A 3-dimensional (perspective) illustration of the above slots are provided in FIG. 4A (for the slot 10a of FIG. 1) and in FIG. 4B (for the slot 11b of FIG. 2).

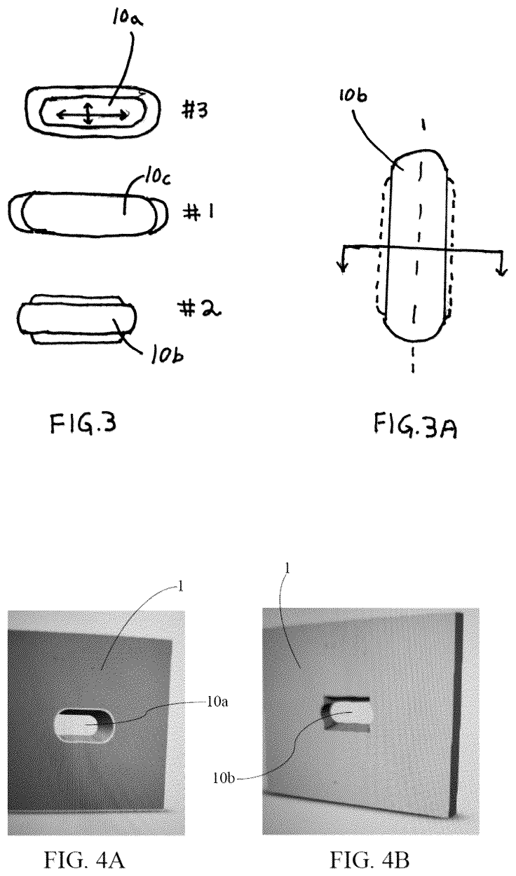

In FIG. 3A, the uppermost sketch is of the slot 10a previously described, and the arrows within the slot are indicative of the fact that the locking elements that are used with that slot “grab” or hold onto the slanted interior surfaces both at the top and bottom, as well as at the two sides. The middle sketch is of a slot that has the slanted surfaces only at the left and right edges, as described in the incorporated by reference Ser. No. 18/085,139 patent application of the instant inventor. The bottom sketch is of the slot 10b previously described, which is also sketched in FIG. 3A.

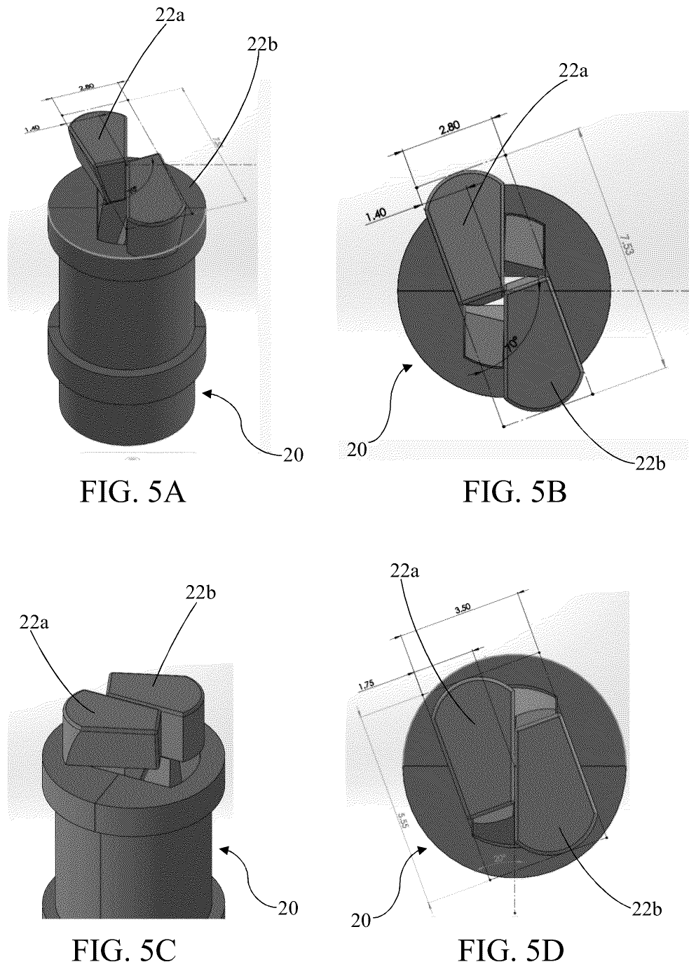

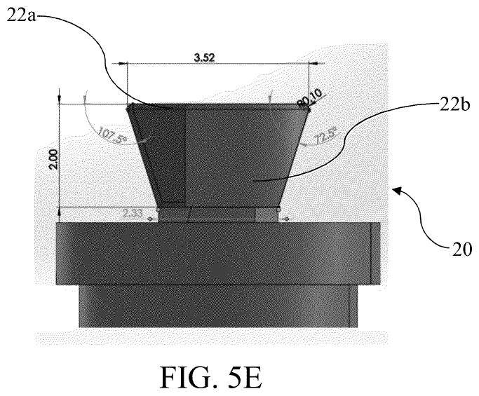

The FIGS. 5A through 5E depict a security lock 20 that is configured especially for the lock slot 10b. Thus, the lock 20 comprises a lock body which support within two locking elements 22a and 22b that jut out from the front surface of the lock body. Each of the locking elements 22a, 22b has a generally “petal-shape” top surface and two side surfaces, an inner surface and an outer surface. The inner surfaces are flat and abut each other so that the locking elements can slide relative to each other, for example from the position shown in FIG. 5B to the position shown in FIG. 5D and back.

In the position shown in FIG. 5B, the combined, width-wise extension of the locking elements 22a, 22b is just under 2.8 mm, which allows them to be inserted into the slot 10b (which preferably has that width dimension at the opening into the slot 10b). The outer surface of each locking element 22a, 22b is inclined inwardly by the same angle as that mentioned for the upper and lower surfaces of the slot 10b. Hence, when the internal mechanism inside the lock body moves/slides the locking elements to overlap as shown in FIG. 5D, the combined width of the locking elements increases to 3.5 mm, which causes these elements to tightly engage with the slanted upper and lower surface inside the slot 10b, effecting a strong locking of the lock 20 to the wall 1 via the slot 10b.

The various angles of inclination shown in FIG. 5E are preferred dimensional measurements, and the actual length of the locking elements can be different than 2.0 mm, for example from 1.75 to 2.3 mm (+/−0.2 mm). So too with the angular measurements. They can range from a minimum to a maximum value as noted above.

In other embodiments (not shown), the lock 20 can have a different construction that enables the lock to grasp onto the slanted walls inside the slot 10a all around, or substantially all around, the interior, slanted surfaces of the slot 10a.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A lock assembly for preventing theft of an electronic mobile device (EMD) having a slot formed in an outer wall of the EMD, wherein the outer wall has a thickness of less than 2.5 millimeters measured from a front surface to a rear surface of the outer wall, and the slot has an opening thereinto at the front surface, the slot having arcuately-shaped left and right walls, and top and bottom outwardly flaring walls extending between the left and right arcuately-shaped walls and away from the opening at the front surface of the outer wall to an opening at the rear surface of the outer wall, the lock assembly comprising:
a lock body including a user-controlled locking mechanism;
a first locking element that protrude from a front wall of the lock body, and the first locking element is configured to be insertable into the slot via the opening at the front surface and has a top wall that is complementary in shape to the top wall of the slot and configured to be laterally and slidingly movable in the slot to tightly engage the top wall of the slot, and the first locking element is configured to prevent insertion thereof beyond the outer surface of the slot;
a second locking element that is insertable into the slot via the opening at the front surface and has a bottom wall that is complementary in shape to the bottom wall of the slot and a configuration that prevents insertion of the first locking element beyond the outer surface of the slot, the first and second locking elements cooperating structurally with each other to become wedged inside the slot in a manner that prevents separation of the lock body from the EMD while the first and second locking elements are positioned inside the slot; and
a cable assembly coupled to the lock body and configured to enable affixing the lock body to an immovable object, whereby when the lock body is affixed to the EMD via the locking elements being engaged with the slot, theft of the EMD is prevented.

2. The lock assembly of claim 1, wherein the locking mechanism is coupled to the second locking element and configured to lock the second locking element inside the slot.

3. The lock assembly of claim 1, wherein the first and second locking elements extend from the lock body at a length in the range from 1.9 to 2.25 mm.

4. The lock assembly of claim 1, wherein the second locking element is slidable into and out of the lock body.

5. The lock assembly of claim 1, wherein the first and second locking elements have substantially same height dimensions and a width dimension of the first locking elements is at least three times as large as a width dimension of the second locking element.

6. The lock assembly of claim 1, wherein the lock body has a bottom surface and the first and second locking elements are provided at a front surface of the lock body, at height that does not exceed 2.5 mm above the bottom surface of the lock body.

7. The lock assembly of claim 1, wherein the locking mechanism is key-operated.

8. The lock assembly of claim 1, wherein the EMD is a laptop.

9. The lock assembly of claim 1, wherein the opening at the front surface into the slot is registered with a USB socket located inside the EMD and accessible through said opening.

10. The lock assembly of claim 1, wherein the slot has arcuately-shaped left and right flaring side walls that extend away from the opening at the front surface to the opening at the rear surface of the outer wall, wherein the first locking element has an arcuately-shaped side that is complementary in shape to the left outwardly flaring side wall and is configured to tightly engage the left outwardly flaring side wall of the slot, wherein the second locking element has an arcuately-shaped side that is complementary in shape to the right, outwardly flaring side wall of the slot and a configuration that prevents insertion of the first locking element beyond the outer surface of the slot.

11. The lock assembly of claim 10, wherein the arcuately-shaped walls extend over an arc angle in the range of 120 to 180 degrees, and wherein the arcuately-shaped side of at least one of the first and second locking elements has an arc-angle of between 120 to 180 degrees.

12. The lock assembly of claim 10, wherein the top and the bottom walls and/or the right and left walls flare at an angle in the range of from 25 to 75 degrees relative to a plane of the opening into the slot.

13. The lock assembly of claim 12, wherein the top and the bottom walls and/or the right and left walls flare at an angle in the range of from 35 degrees relative to a plane of the opening into the slot.

14. The lock assembly of claim 10, wherein the arcuately-shaped side of the first locking element is oriented on a side thereof opposite to the location of the arcuately-shaped side of the second locking element, and the first and second locking elements are insertable together into the slot.

15. The lock assembly of claim 10, wherein the arcuately-shaped side of at least one of the first and second locking elements has an arc-angle of about 180 degrees.
